(19) United States
(12) Patent Application Publication
(10) Pub. No.: US 2018/0068764 A1
(43) Pub. Date: Mar. 8, 2018

(54) CONDUCTOR AND CONDUIT SYSTEMS

(71) Applicant: Coreteq Systems Limited, Bagshot Surrey (GB)

(72) Inventors: Philip Head, Virginia Water Surrey (GB); Hassan Mansir, Maidenhead Birkshire (GB)

(21) Appl. No.: 15/695,186

(22) Filed: Sep. 5, 2017

(30) Foreign Application Priority Data
Sep. 5, 2016 (GB) 1615040.1

(51) Int. Cl. H01B 7/18; H01B 1/02; H01B 7/00; E21B 17/00

(52) U.S. Cl. CPC H01B 7/1875; H01B 1/026; H02G 1/14; E21B 17/003; H01B 7/0009

(57) ABSTRACT

A downhole cable is made from a copper clad steel conductor, to which an insulator layer is applied to, and then a plurality of thin wall layers is applied around the insulator layer. Each of the thin wall layer is joined and sealed along a longitudinal seam by welding, and swaged to fit against the previous layer.

### CROSS-REFERENCE TO RELATED APPLICATIONS

This application claims priority to and the benefit of Great Britain Patent Application No. GB1615040.1, filed Sep. 5, 2016, the entirety of which is hereby incorporated by reference as if fully set forth herein.

This invention relates to conductor and conduit systems, particularly but not exclusively in sub-sea and sub-surface environments, for the production of oil and gas and associated tasks.

Conductor systems such as armoured cables are much used in the drilling of boreholes and the subsequent production of oil, both to supply power and to transmit signals. The conditions that such conductor systems encounter are harsh; cabling may be subjected to the high pressures of the well fluid, mechanical stresses from being pulled upon or compressed by surrounding components, aggressive chemicals and high temperatures.

Other types of line that may be used in these environments, such as hydraulic and fibre optic lines, must be designed with the same considerations in mind.

A major problem identified with existing power cables is that gas migrates into the conductor; some gas, such as hydrogen sulphide, is highly corrosive to the copper typically used for conductors. Also, the gas permeates slowly under high pressure into the elastomer jacket and insulation material. If the cable suddenly decompressed (for example a seal or a pump fails) the gas in the cable expands and can cause the cable to explode, commonly called explosive decompression.

Known armoured cable is typically formed by wrapping multiple layers of different material around the conductors or piping to be protected. The complex production process results in armoured cable being relatively expensive.

It is an object of the present invention to provide a reliable conductor or conduit system that is convenient to manufacture. Other objects of the invention will become apparent from time to time in the description.

According to the present invention there is provided a method of forming a connection to a cable for transmitting power or telemetry data in a down hole environment, the cable including a conductor, and a tubular metallic impermeable layer around the conductor, comprising exposing the end of the conductor, introducing the conductor to a bore in a housing, the bore containing an electrical contact which abuts the conductor, the housing sealing against the metallic impermeable layer to isolate the bore of the housing.

Preferably the cable includes a multi-layered steel tube jacket over copper clad steel conductors.

Preferably the cable includes an outer coating, this outer coating being removed to expose the metallic impermeable layer.

According to another aspect of the present invention there is provided a method of forming a protected cable for transmitting power or telemetry data in a down hole environment, comprising the steps of feeding the cable through an extruder to form a first layer of extrudate substantially encompassing the cable, applying a metal impermeable thin wall tube of a larger diameter than the first layer of extrudate around the first layer of extrudate, and swaging the thin wall metal impermeable tube so that it is snug fit to the first layer of extrudate.

The metal impermeable tube may be applied as a sheet and formed into a seam welded tube.

According to another aspect of the present invention there is provided a protected conduit for use in a in a down hole environment, comprising a first thin wall tubular metal impermeable layer.

According to another aspect of the present invention there is provided a protected conduit for use in a in a down hole environment, comprising a first thin wall seam welded tubular metal impermeable layer, a second thin wall seam welded tubular metal impermeable layer.

According to another aspect of the present invention there is provided a protected conduit for use in a in a down hole environment, comprising a first thin wall seam welded tubular metal impermeable layer, a second thin wall seam welded tubular copper impermeable layer which acts as a screen.

According to another aspect of the present invention there is provided a protected conduit for use in a in a down hole environment, comprising more than one thin wall seam welded tubular metal impermeable layers, formed over each other and swaged to a snug fit.

Preferably, the conducting means comprises three parallel mutually insulated conductors.

According to a further aspect of the invention an outer extruded layer may be applied to mechanically protect the outer metal impermeable layer and also incorporate features to enable the cables to be connected together,

According to another aspect of the present invention there is provided a protected cable for transmitting power or telemetry data in a down hole environment, comprising conductive cable, a first extrudate layer applied upon the cable, a first metal impermeable layer applied upon the first extrudate layer, and a plurality of tensile support members applied upon the first metal impermeable layer.

The tensile support members are preferably applied upon the first metal impermeable layer in a braided configuration.

The invention will now be described, by way of example, reference being made to the accompanying drawings, in which:

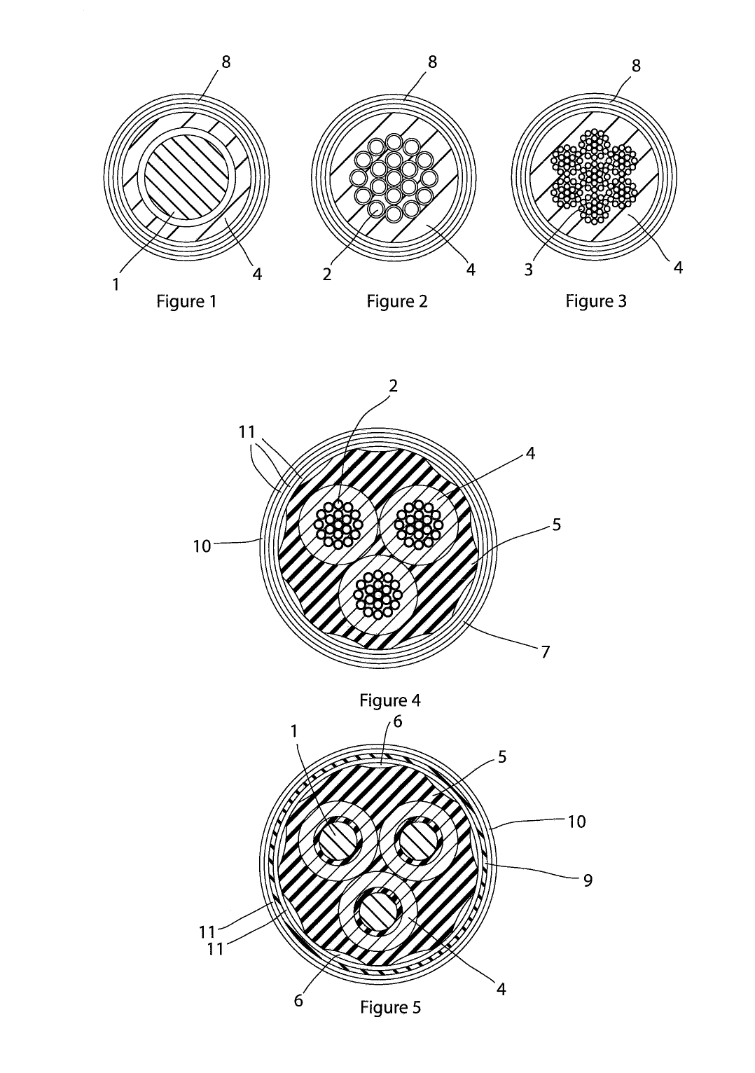

FIG. 1 is an end cross section view of a copper clad steel conductor encased in an insulation layer, further encased in a multi-layer impermeable steel tube jacket

FIG. 2 is an end cross section view of a multi stranded copper clad steel conductor encased in an insulation layer, further encased in a multi-layer impermeable steel tube jacket

FIG. 3 is an end cross section view of a litz constructed copper clad steel conductor encased in an insulation layer, further encased in a multi-layer impermeable steel tube jacket

FIG. 4 is an end cross section view of a three phase multi stranded copper clad steel conductors encased in an insulation layer, further encased in an elastomer jacket and then further encased in a multi-layer impermeable steel tube jacket

FIG. 5 is an end cross section view of a three phase solid copper clad steel conductors encased in an insulation layer, further encased in an elastomer jacket and then further encased in a multi-layer impermeable steel tube jacket, one of the layers being copper to act as a screen.

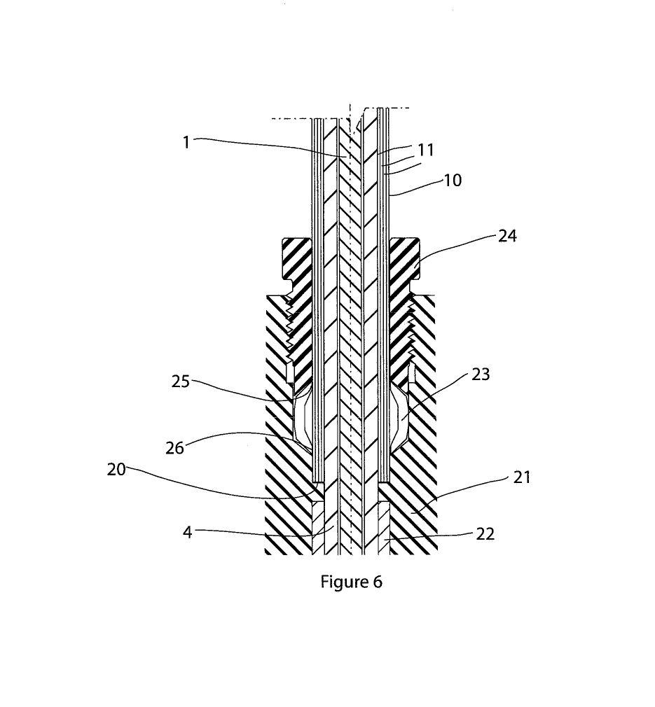

FIG. 6 is a section side view of a metal to metal seal for cable termination.

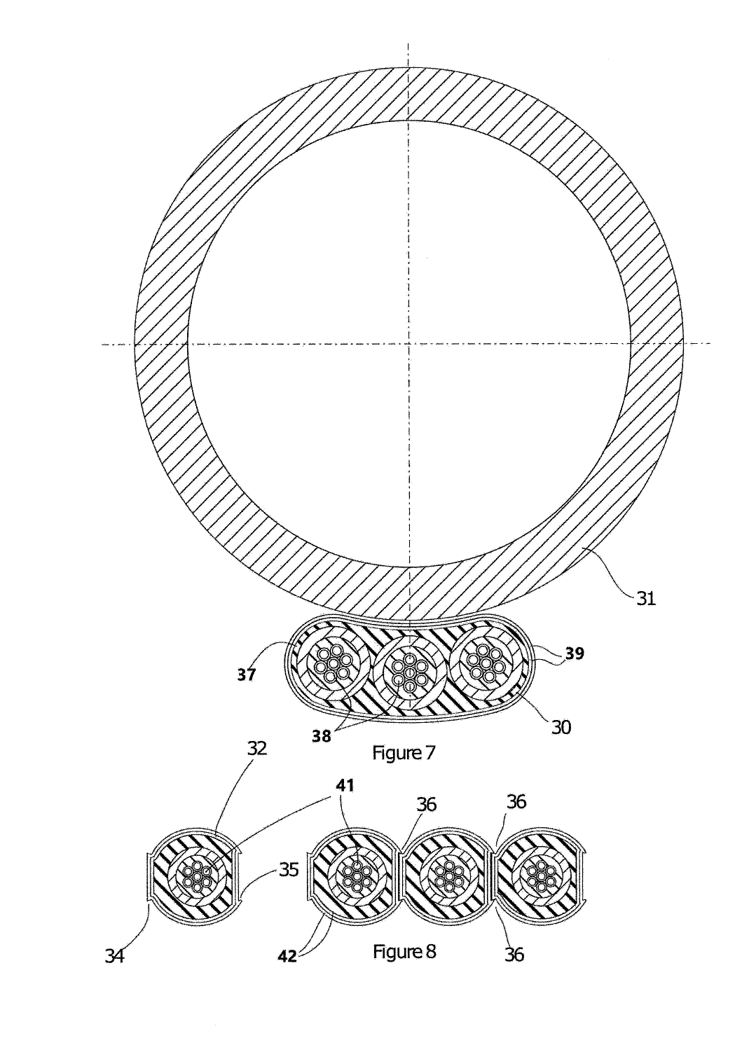

FIG. 7 is a section end view of a flat pack arrangement three phase multi stranded copper clad steel conductor, in an impermeable metal jacket, encased in a elastomer flat pack jacket shaped to fit snuggly to the OD of the tube it is attached too.

FIG. 8 is a flat pack arranged three phase multi stranded copper clad steel conductor in an impermeable metal jacket and a shaped external elastomer jacket which interlinks together to form multi cable arrangement.

FIGS. 1 to 5 to various configurations of conductors which are treated with thin wall layers in a similar way. In FIG. 1, there is shown a solid copper clad steel conductor 1, FIG. 2 shows a multi stranded copper clad steel conductor 2 and FIG. 3 shows a litz constructed copper clad steel conductor 3. Referring to FIGS. 4 and 5, which show possible 3 phase conductor arrangements, an electrical insulation layer 4 is applied to each conductor (for example by extrusion), and then an elastomer jacket 5 is applied to all three conductors, which provides increased electrical insulation, and also forms a round structure. Small cavities 6 may be used to accommodate any small change in volume of the assembly already described which is encased in a multi-layer steel jacket 7. The multi-layer steel jacket 8 is also fitted around the single conductors in FIGS. 1-3. The reason for the multi-layer steel outer jacket is that the thin steel layer is easy to form into a cylinder around the insulation 4 and be laser welded without causing any irreversible damage to the insulation 4, it can then be easily swaged down is size to make a snug fit to the insulation 4. Additional layers can then be applied using the same process to build up the total wall thickness. This increases the mechanical strength and the collapse pressure rating of the structure. In addition, the material for each layer can be a different, for example, the inner layers could be nickel plated steel 11 and only the outer could be monel or Inconel or stainless steel 10, so a premium material on the outside and a cost effective material on the inside. Alternatively, a layer could be copper 9, which would act like an electrical shield. Furthermore, the layered structure of this cable would make it far more flexible compared to a tube of a similar thickness. This is significantly advantageous in reducing the diameter of the reel and for deployment.

The thin layers may be swaged so that some movement is still permitted between the thin layers; this can reduce the stress on the structure, for example if the cable is bent (for example, if it is wound and unwound on a mandrel) or if the cable has a twisted.

Referring to FIG. 6 there is shown a termination of the cable shown in FIG. 1. The outer multi-layer steel tube are cut back 20 a distance along the insulation 4 and the insulation continues into the termination block 21 and its insulation 22 to a female termination not shown. The swage lock type metal to metal seal 23 is energised by the retaining nut 24. It applies a line seal on the outer surface 25 and 26 and remains energised regardless of temperature and pressure. The thick wall of the multi-layered steel tube resists the compressive force of the seal 23, and does not transmit any of this compressive force to the insulation 4. The insulation is not subjected to any mechanical stress, and hence does not creep or weaken as a result.

Referring to FIGS. 7 and 8 the flat pack three phase cable 30 can be shaped to fit the outside profile of the tube 31 it is attached to when it is run into the well. One way of producing this would be to extrude the elastomeric layer 37 over the conductors 38 when arranged in a side-by-side formation, optionally form, seam weld, and swage the thin metal layers 39 over the elastomeric layer, and then introduce a concave and convex curve to opposite sides of the cable 30 using shaped rollers.

Alternatively, the individual conductors 41 can have an external jacket 32 extruded onto it, and optionally have thin metal layers 42 applied, which are shaped with male 34 and female 35 dove tail features. This enables the any number of conductors to be clipped together 36, and also has the added benefit of being easier to strip for termination.

Laser welding has been used as a suitable method of seam welding the thin layers; however other methods of welding, such as ultrasonic welding and friction welding, can also be employed.

1. A downhole cable comprising:
a copper clad steel conductor,
an insulator layer around a copper clad steel conductor,
a plurality of thin wall layers around the insulator layer,
each thin wall layer being joined and sealed along a longitudinal seam by a welding process, and swaged to fit against the previous layer.

2. A downhole cable according to claim 1, wherein the cable includes an outer coating, this outer coating being removable to expose the metallic impermeable tube.

3. A downhole cable according to claim 1, wherein at least one of the thin walls is copper.

4. A downhole cable according to claim 1, the copper clad steel is multi stranded.

5. A downhole cable according to claim 1, where in the copper clad steel is litz type construction.

6. A downhole cable according to claim 1, wherein two or more copper clad steel conductors are spaced side-by-side in the cable, and the cable is shaped after the thin walls have been applied.

7. A protected conduit for use in a in a down hole environment, comprising a first tubular metal impermeable layer, a first extrudate layer applied upon the first metal impermeable layer, and a second layer formed a plurality of thin metal impermeable layers applied upon the first extrudate layer.

8. A protected conduit according to claim 7, wherein the conducting means comprises three parallel mutually insulated conductors.

9. A protected cable for transmitting power or telemetry data in a down hole environment, comprising conductive cable, a first extrudate layer applied upon the cable, a first metal impermeable layer applied upon the first extrudate layer.
